(19) United States
(12) Patent Application Publication
(10) Pub. No.: US 2010/0014648 A1
(43) Pub. Date: Jan. 21, 2010

(54) Method of Connecting Audio Advertising Information to Visual Display Advertisements

(76) Inventors: Thomas S. Baglio, Indiana, PA (US); Amy L. Hiltabidel, Mill Run, PA (US)

Correspondence Address: MEYER UNKOVIC & SCOTT LLP, 535 Smithfield Street, Suite 1300, Pittsburgh, PA, 15222-2315, US

(21) Appl. No.: 12/506,518

(22) Filed: Jul. 21, 2009

Related U.S. Application Data
(60) Provisional application No. 61/135,516, filed on Jul. 21, 2008.

(51) Int. Cl. H04M 11/00; G06Q 30/00; B42D 15/00

(52) U.S. Cl. 379/88.13; 40/624; 283/56; 705/14.4

(57) ABSTRACT

A method and system for connecting an audio message containing advertising information to a visual display advertisement is provided.

### CROSS-REFERENCE TO RELATED APPLICATION

This application claims priority under 35 U.S.C. § 119(e) to provisional application Ser. No. 61/135,516, filed Jul. 21, 2008, incorporated by reference herein in its entirety.

### FIELD OF INVENTION

The present invention relates to the fields of combining an audio sales presentation with an advertiser's visual display advertisement(s) that will allow consumers to access instant information about the advertiser's service and/or product via a cellular telephone or touch tone landline.

### BACKGROUND

Time pressured consumers are demanding more time sensitive Medias. In today's market information needs to be convenient, concise, reliable, user-friendly, and direct with minimal effort, skill, and time needed to access information. Information must be delivered in a way that is appealing, up to standards of technology that exist today, technology that is easily accessible-at the consumer's fingertips no matter the location. The technology that meets these criteria is the cellular telephone. With the United States population over 300,000,000 in the year 2008, 80% of the United States population are cellular telephone subscribers in that same year. Cellular telephone subscribers have dramatically increased over the last thirteen years. And with the continuous evolution of the cellular telephone the predication is that this number will continue to increase.

Businesses need to achieve the highest possible return on investment from their advertising dollars. They need a more accurate advertising format for attracting targeted consumers to their product and/or service in the “window of opportunity” i.e. the consumer has identified a need or desire to make a purchase. Advertisers also find it difficult to find an accurate method of gauging consumer response to their visual display advertising, i.e. newspapers can provide an advertiser with circulation numbers by households, but cannot accurately tell an advertiser the exact number of consumers that read their visual display advertisement(s). With outdoor billboard display(s), billboard advertising agencies can provide to advertisers the traffic count that passes a particular billboard display, but they are unable to provide to the advertiser the exact number of consumers that read and register the information on that billboard. Advertisers also need to create consumer loyalty. Their business is dependent on consumers consistently returning to the product and/or service they provide. Accurate and additional information to consumers supports this loyalty.

Visual Display Agencies are continuously searching for ways to create client loyalty by giving them an advantage to using their product(s) over other Medias. They realize with the intense competition for advertising dollars they need a cost effective means of maintaining existing clients, and to entice new advertising clients to use their product(s).

The drawback with visual display advertisements is advertisers try to promote too much information into the amount of space afforded them in visual display advertising, hereby confusing the consumer and losing their interest.

Informational signage, such as the typed used with amusement parks, highway signs, special events, and the like, instructs consumers to tune to a specific AM radio station for additional information. This old technology inhibits the consumer by being time sensitive, and this form of AM broadcasting has limited range.

There is no service/system presently that will allow consumers to access immediate, additional information about an advertiser's service and/or product at the exact time as viewing a visual display advertisement(s) without directly contacting the advertiser.

### SUMMARY OF THE INVENTION

The present invention provides to each advertiser, exclusive to their business, an information code placed on their visual display advertisement(s) that will allow consumers to access, free of charge, information on that particular advertiser's service and/or product at the exact time as viewing their visual display advertisement(s). As consumers are viewing an advertiser's visual display advertisement(s), they will call a toll free number, enter the advertiser's exclusive information code, and instantly listen to the advertiser's audio sales presentation (similar to a 60-second radio commercial).

The present invention, by use of a cellular telephone, allows consumers to virtually access information from anywhere at any time. It also vastly improves the effectiveness of the technique of visual display advertising, by adding an audio sales presentation to each specific advertiser's visual display advertisement creating total informational coverage.

The present invention gives to consumers information that is instant, reliable, non-cluttered, and non-intrusive. They have the ability to access information when they want it and from where they want it, free of charge, twenty-four hours a day, seven days a week through technology that is at their fingertips, cellular telephone or touch tone landline.

The present invention allows advertisers to effectively gauge consumer response. Advertisers will receive a monthly tracking report associated with their exclusive information code that will provide to the advertiser the exact number of responses by targeted consumers to their visual display advertisement(s). By enhancing their visual display advertisement(s) with an audio sales presentation, the advertiser is able to extend the longevity of their visual display advertisement(s) by easily updating the corresponding audio sales presentation that accompanies that particular visual display. The present invention also increases consumer loyalty for the advertiser by giving the consumer the ability to consistently access this updated information. Advertisers need to spend their advertising dollars in the most cost effective manner. The invention provides to advertisers all the stated benefits at a lower cost per thousand than most other Medias.

The present invention provides to Visual Display Agencies the advantage they need to maintain existing clients. This provides a competitive advantage for their advertising clients by giving them a combination of optimum visual and audio exposure at an affordable price. The present invention will assist the Visual Display Agencies in creating client loyalty, by securing long term advertising contracts, and increasing visual display usage. The present invention will also assist Visual Display Agencies in generating new advertising clients to their product(s) by clients wanting to immolate their competition.

Although visual display advertising is an effective means of advertising, the present invention will take it one step further through a new technology and innovative service, the consumer will be able to view the visual display advertisement(s) and immediately follow-up with an audio bite offering further, more pertinent information about that specific advertiser's product and/or service.

The present invention solves the problem of cluttered visual display advertisements. Most visual display advertisements have size restrictions to advertisers. Advertisers are usually confined to brand advertising due to the limited amount of space they have to get their message to consumers or they try to promote too much information on their visual display advertisement(s), hereby confusing the consumer and losing their interest. By utilizing an audio sales presentation to enhance an advertiser's visual display advertisement(s), it allows the advertiser to place less information on their visual display advertisement(s) hereby “wetting the consumer's appetite” for more information. The present invention will excel in this market because it will give consumers more information on the advertiser's product and/or service free of charge, twenty-four hours a day, seven days a week.

### BRIEF DESCRIPTION OF DRAWINGS

FIG. 1 is a flow chart of an embodiment of the process of the present invention.

FIG. 2 is a diagram of an embodiment of the telephone system of the present invention.

### DETAILED DESCRIPTION OF THE INVENTION

Accordingly, the present invention provides a system for connecting an audio message containing advertising information to a visual display advertisement, the system comprising the following components:
a) said visual display advertisement;
b) a visual symbol indicating that the owner of the visual display advertisement subscribes to said system, said symbol displayed on the visual display advertisement;
c) a unique code identifying the owner of the visual display advertisement and the product advertised thereon;
d) a telephone system with an identifying telephone number and with a plurality of ports, each port configured to receive a telephone call via the unique code, so that each code provides a one-to-one direct access to the audio message; and
e) an audio message corresponding to each port in the telephone system, each audio message containing additional information about the product(s) shown on the visual display advertisement.
   wherein a customer, upon viewing the visual display advertisement, can recognize that the owner of the advertisement subscribes to said system, and wherein when the customer uses the telephone number to access the audio message, access is provided directly to the audio message corresponding to the unique code, without the need for searching a database, responding to additional questions or providing additional information.

In an additional aspect, the invention provides a method for connecting an audio message containing advertising information to a visual display advertisement viewed by a potential consumer, the method comprising the following steps:
a) providing a system comprising the following:
   a visual display advertisement displaying an advertiser's goods and/or services;
   a visual symbol indicating that the owner of the visual display advertisement subscribes to said system, said symbol displayed on the visual display advertisement;
   a unique code identifying the owner of the visual display advertisement and the product advertised thereon;
   a telephone system with an identifying telephone number and with a plurality of ports, each port configured to receive a telephone call via the unique code, so that each code provides a one-to-one direct access to the audio message; and
   an audio message corresponding to each port in the telephone system, each audio message containing additional information about the product(s) shown on the visual display advertisement;
b) connecting to said telephone system having a plurality of ports via said telephone number;
c) entering a unique code or identification information identifying the advertiser's goods or services displayed on the visual display advertisement, said unique code or identification information entered by the consumer via a keypad through said connection means,
wherein access to the audio message corresponding to the unique code or identification information is provided directly, without the need for searching a database, responding to additional questions or providing additional information.

The present invention supports a method and system for alerting consumers to the fact that while viewing an advertiser's visual display advertisement, they have the capability to access additional information about that advertiser's service and/or product through an information code exclusive to that particular advertiser. This means that each advertiser's visual display advertisement is directly matched to an audio information code that only pertains to that advertiser's particular visual display advertisement.

By utilizing a unique information code a one-to-one correlation is created between the advertiser's visual display advertisement and their audio sales presentation. This method of one-to-one correlation is novel because the information code allows consumers to directly access the advertiser's audio sales presentation without searching a data base, answering additional questions, or inputting additional information to reach the specific audio sales presentation for that particular advertiser. The exclusive information code is displayed on the advertiser's visual display advertisement(s). The present invention also allows consumers to retain the information code to access updated information at a later date when and from where they desire it.

In one embodiment, when a web site is the source of the visual display advertisement, the audio message is available on a computer via a link to the web site containing the visual display advertisement, and a consumer clicks on the link to access and listen to the audio message.

Exemplary embodiments of the invention can be more readily understood by reference to the accompanying figures.

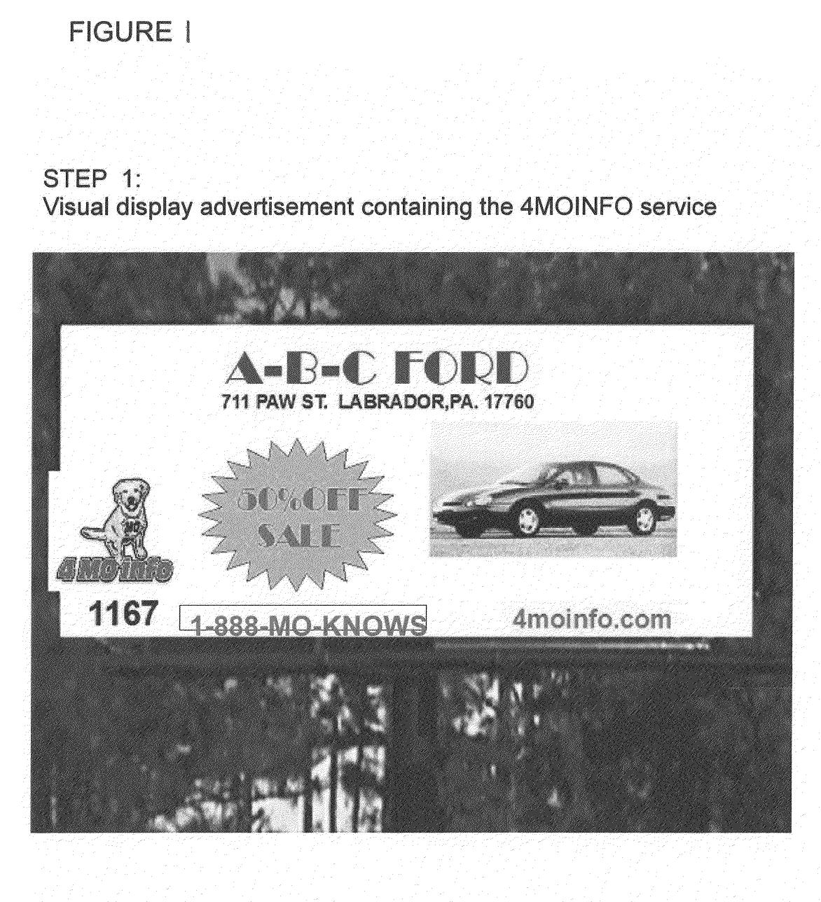

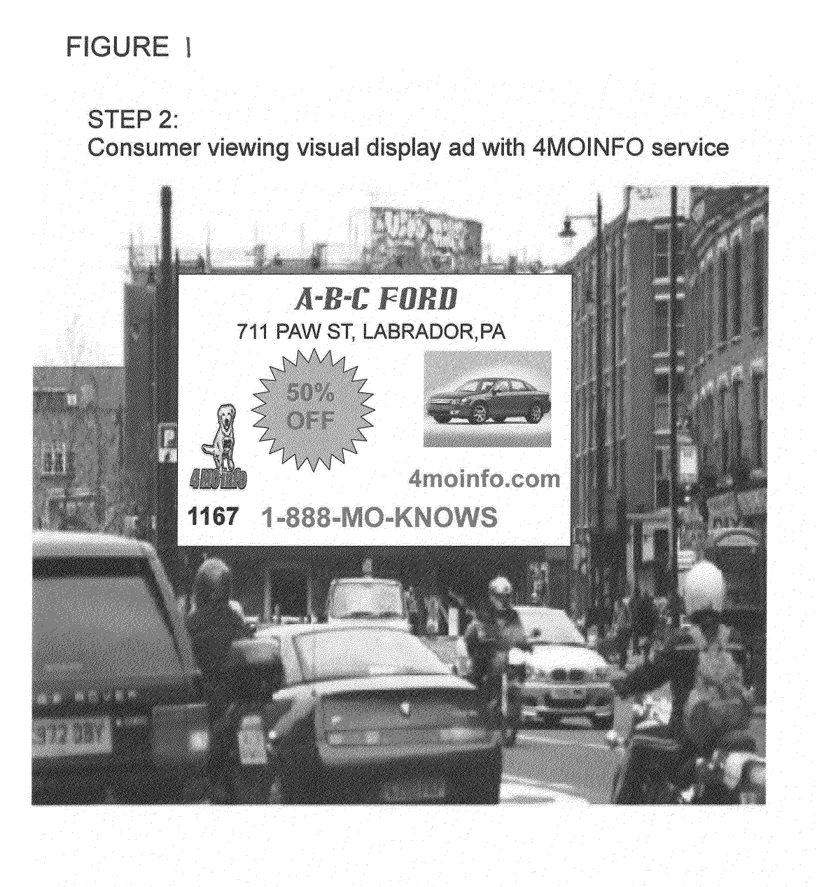

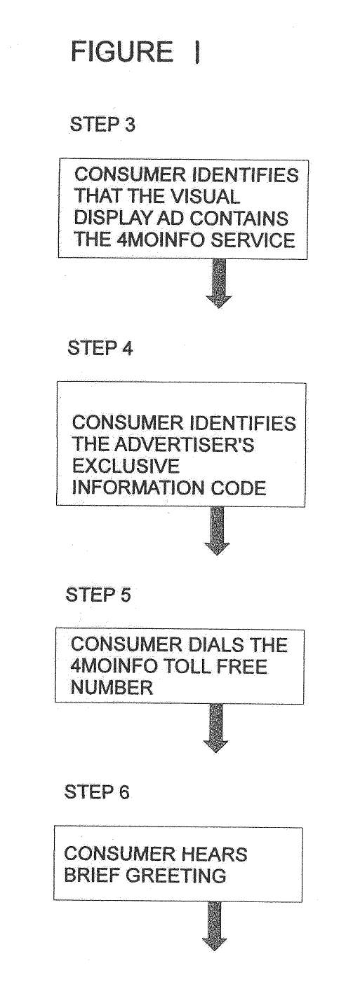

Referring now to the drawing listed as FIG. 1, an exemplary embodiment of the present invention is shown. There is a minimal number of steps which equates to a minimal amount of time to access the information.

FIG. 1:
Step 1—This is an example of a visual display advertisement that utilizes the present invention. There is minimal information promoted on this advertisement.
Step 2—Consumers will view the visual display advertisement.
Step 3—Consumers will identify the visual display advertisement as utilizing the service provided by the present invention. Consumers can identify a visual display advertisement as embraced by the present invention by the presence of one or more of the following on the visual display: a trademark, logo, signature, company name, and/or a toll free number, such as 1-888-MO-KNOWS, displayed on the visual display(s).
Step 4—Consumers will identify the unique information code assigned to that particular advertiser. The exclusive information code can be any combination of numbers and/or alpha numeric characters. The exclusive information code is also displayed on the visual display advertisement(s).
Step 5—Via their cellular telephone or touch tone land line the consumer will dial the toll free number shown on the visual display.
Step 6—Consumers will hear a brief greeting. For example “Hello, welcome to 4MOINFO”.
Step 7—Consumer is prompted to enter the preferred advertiser's exclusive information code.
Step 8—Consumer will enter the information code through their cellular telephone keypad or by a touch tone land line.
Step 9—The consumer will hear the audio sales presentation associated with the advertiser whose information code was entered. The caller could then through an automated service be given multiple options, for example: to repeat the audio sales presentation they just heard, to hear additional audio sales presentations associated with that particular advertiser, or the consumer may be given the opportunity to enter a different information code to access another advertiser's audio sales presentation. Audio sales presentations will generally be sixty second spot, but could be as long as three minutes.
Step 10—After hearing the advertiser's audio sales presentation the consumer will be presented the option of ending the call or to have the advertiser's exclusive information code text to their cellular telephone for future access to updates.
Step 11—Consumer will press the number one on their cellular telephone keypad to accept the information code via text or the number two to reject the text.
Step 12—Call ends.

### Variations of Steps 7 & 8

Variation 1—If the consumer want to access information about a particular advertiser's audio sales presentation and does not enter the information code when prompted, the consumer will then be prompted to voice command a portion of the advertiser's business name.
Variation 2—If there are more than one business with the same voice command associated with their business name, the consumer will be prompted to choose the business by numerical order, i.e., “Press 1 for business ______press 2 for business ______”.
Variation 3—Once the consumer enters the correct alphanumerical digit for the preferred advertiser the consumer will be directed to that particular advertiser's audio sales presentation. Consumer will then proceed to step 9.

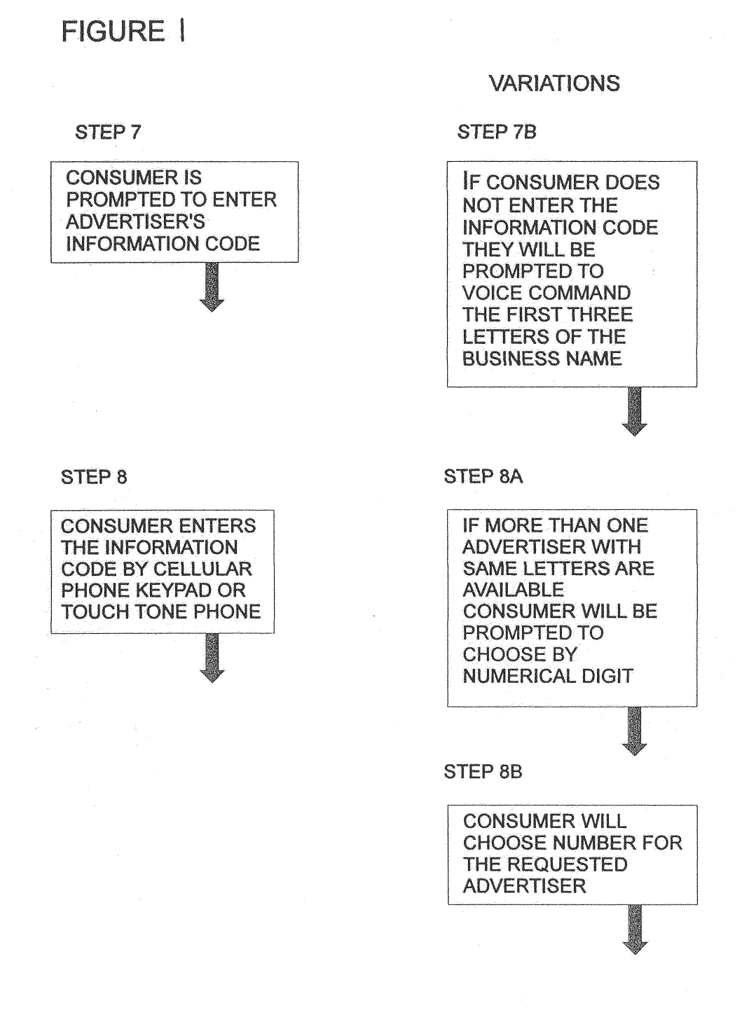

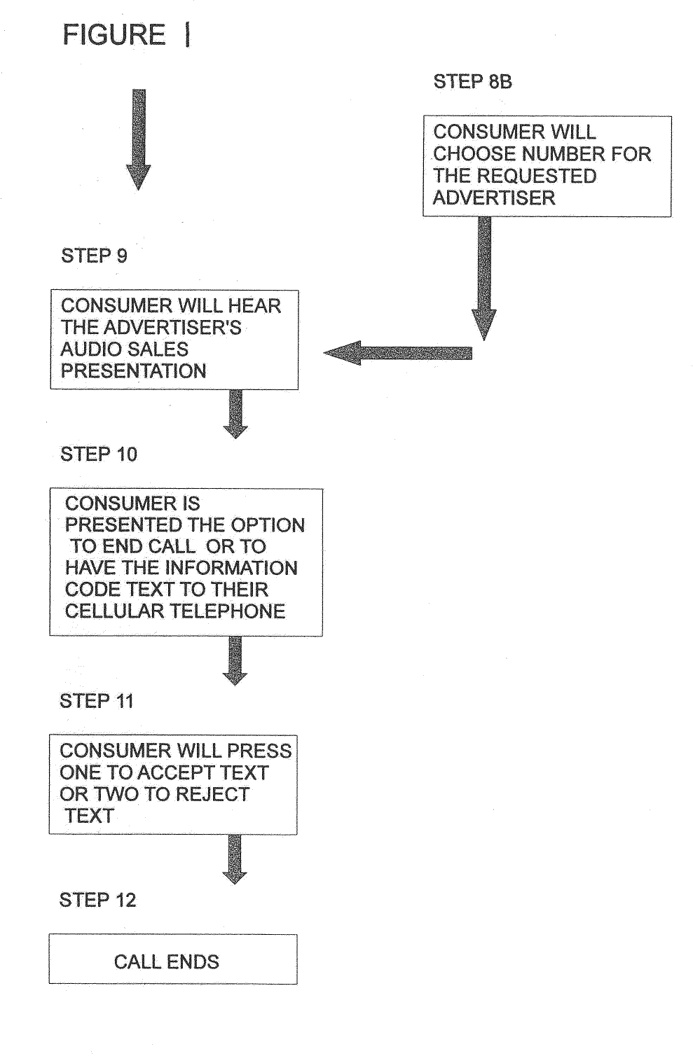

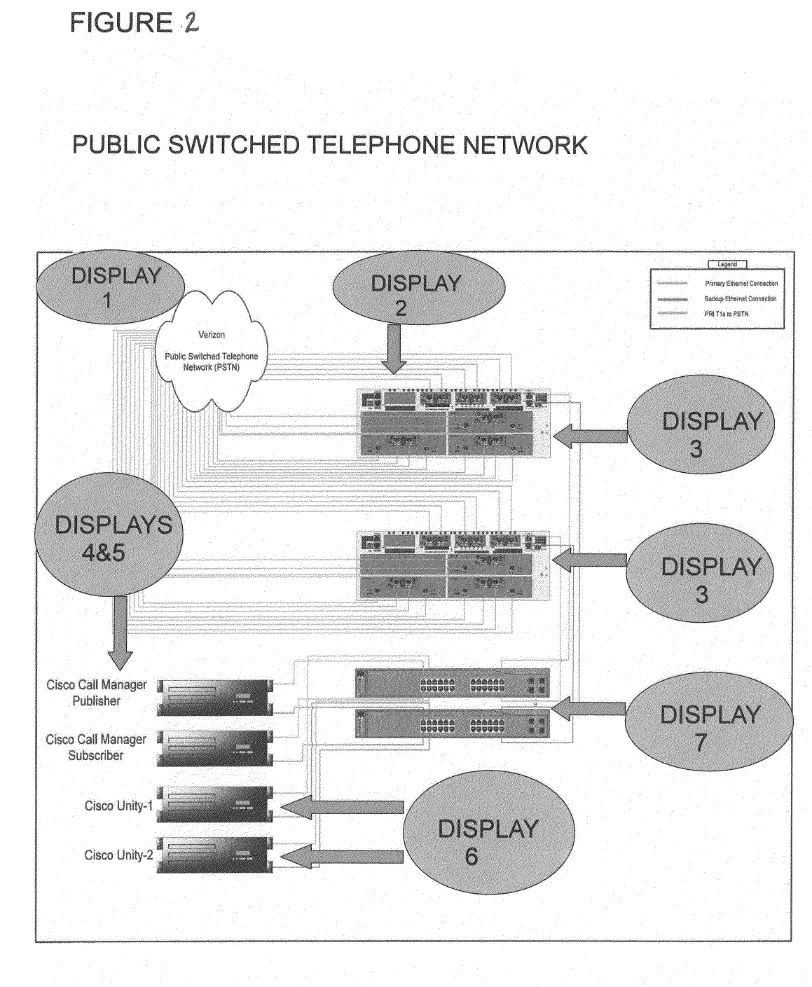

Referring now to FIG. 2:

The telephone system that has been designed for the present invention is based on IP(Internet Protocol) telephony. The phone system has been designed in a manner that it can be expanded by adding additional Voice Gateways configured with any number of PRI T1 ports the said company deems necessary to keep up with the demand of inbound calls into the network.

display 1—Public Switched Telephone Network (PSTN)A typical user will dial the advertised toll-free number from where ever they may be (cellular telephone or touch tone land line)
display 2—PRI T1—The user's call traverses the Public Switched Telephone.

Network (PSTN)(FIG. 1) and comes into the phone system of the present invention via one of the PRI T1's. In one embodiment, each PRI T1 handles a maximum of 23 simultaneous calls. In additional embodiments the PRT T1's can be configured to handle more calls, such as 30, 40, 50, 60, 70, 80, 90, or 100 calls, or any number between 1-100, or higher, as necessary to handle the call volume.

display 3—Routers. The PRI T1's (FIG. 2) are connected and housed to the routers. Multiple routers will be used initially to perform the redundancy function. As the system is expanded routers and PRI T1's (FIG. 2) will be added as needed. The design that has been configured will provide, in one embodiment, the capability to handle 828 simultaneous calls into the phone system. An unlimited amount of phone systems will be added to keep up with demand, such as 1,000, 2,000 or up to 10,000 calls, or any number in between, to provide additional call volume.
display 4&5—The call will then be processed by the call manager publisher and the call manager subscriber.
display 6—The call will be answered by the unity server(s).
display 7—Directory Handlers. There will be a shortcut greeting presented to the caller asking them to enter the advertiser's exclusive information code or voice command a portion of the business name. The codes will actually be “Directory Handlers” configured on the Unity Server (FIG. 3). The “directory handler will be also able to identify the specific information code for the requested advertiser by the portion of the business name. You can think of the directory handler as a specific area on the unity server (FIG. 3) that plays a prerecorded audio sales presentation based on the specific information code that was entered by the caller. The directory handler can be modified to what ever the information code will pertain to.

In an additional embodiment, a website having multiple purposes and functions is used to link consumers to audio messages containing advertising information for a particular product and company. The website provides information to consumers as to what the said company's service is and where it is found, how the service works, and how consumers can utilizes and access the service. The website provides information to advertisers on what the said company's service is, how the service works, and how the advertisers can utilize the service with their visual display advertising. The audio messages are uploaded to a computer, which is then linked to the advertiser's web page. In one embodiment, this is the same computer on which the web page resides; however, this is not required.

The website will provide information to advertisers, consumers, and visual display advertising agencies on the said company's location(s) and telephone number(s). It will also provide names, telephone numbers, and email addresses for the said company's management and staff.

The website will provide to advertiser's using the said company's service, the opportunity to expand their advertising reach to consumers through advertising spaces on the website such as, but not limited to: leaderboard ad spaces, skyscraper ad spaces, and block ad spaces.

As mentioned above, if the advertiser chooses the web audio option, their information code will be highlighted on the website. This will alert the consumer to click onto the information code and access the advertiser's audio sales presentation just as if they had accessed it through a cellular telephone or landline.

Whereas particular embodiments of this invention have been described above for purposes of illustration, it will be evident to those skilled in the art that numerous variations of the details of the present invention may be made without departing from the invention as defined in the appended claims.

What is claimed is:

1. A system for connecting an audio message containing advertising information to a visual display advertisement, the system comprising the following components:
a) said visual display advertisement;
b) a visual symbol indicating that the owner of the visual display advertisement subscribes to said system, said symbol displayed on the visual display advertisement;
c) a unique code identifying the owner of the visual display advertisement and the product advertised thereon;
d) a telephone system with an identifying telephone number and with a plurality of ports, each port configured to receive a telephone call via the unique code, so that each code provides a one-to-one direct access to the audio message; and
e) an audio message corresponding to each port in the telephone system, each audio message containing additional information about the product(s) shown on the visual display advertisement.
wherein a customer, upon viewing the visual display advertisement, can recognize that the owner of the advertisement subscribes to said system, and wherein when the customer uses the telephone number to access the audio message, access is provided directly to the audio message corresponding to the unique code, without the need for searching a database, responding to additional questions or providing additional information.

2. The system of claim 1, wherein the visual display advertisement is a billboard or other outdoor signage.

3. The system of claim 1, wherein the visual display advertisement is print materials.

4. The system of claim 1, wherein the visual symbol is a logo and/or one or more words.

5. A method for connecting an audio message containing advertising information to a visual display advertisement viewed by a potential consumer, the method comprising the following steps:
a) providing a system comprising the following:
a visual display advertisement displaying an advertiser's goods and/or services;
a visual symbol indicating that the owner of the visual display advertisement subscribes to said system, said symbol displayed on the visual display advertisement;
a unique code identifying the owner of the visual display advertisement and the product advertised thereon;
a telephone system with an identifying telephone number and with a plurality of ports, each port configured to receive a telephone call via the unique code, so that each code provides a one-to-one direct access to the audio message; and
an audio message corresponding to each port in the telephone system, each audio message containing additional information about the product(s) shown on the visual display advertisement;
b) connecting to said telephone system having a plurality of ports via said a telephone number;
c) entering a unique code or identification information identifying the advertiser's goods or services displayed on the visual display advertisement, said unique code or identification information entered by the consumer via a keypad through said connection means,
wherein access to the audio message corresponding to the unique code or identification information is provided directly, without the need for searching a database, responding to additional questions or providing additional information.

6. The method of claim 5, wherein the visual display advertisement is a billboard or other outdoor signage.

7. The method of claim 5, wherein the visual display advertisement is print materials.

8. The method of claim 5, wherein the visual symbol is a logo and/or one or more words.
